(19) United States
(12) Patent Application Publication
(10) Pub. No.: US 2014/0207035 A1
(43) Pub. Date: Jul. 24, 2014

(54) MYOFASCIAL RELEASE APPARATUS AND METHOD

(71) Applicant: Donnie Zimmerman, San Diego, CA (US)

(72) Inventor: Donnie Zimmerman, San Diego, CA (US)

(21) Appl. No.: 13/747,392

(22) Filed: Jan. 22, 2013

(51) Int. Cl. A61H 7/00

(52) U.S. Cl. CPC A61H 7/00
USPC 601/134

(57) ABSTRACT

A myofascial release apparatus which is adapted for use by a user in a vertical position is disclosed. The myofascial release apparatus comprises a post member, a post affixing element and at least one release member. The post affixing element is operatively coupled to the post member at a first end and affixed to the at least one release member at a second end.

### BACKGROUND

1. Field

The present disclosure generally relates to methods and apparatuses for correcting misalignments in a body, and particularly for properly realigning myofascial tissue in the body.

2. Related Art

The body is a synchronous symphony of billions of functional operations at multiple levels ranging from cellular systems to organ systems. Even simply sitting, standing and walking are incredibly complex processes requiring millions of simultaneous and interdependent operations in the body, all of which must be performed with precision in both space and time. Any problems affecting one region of the body may adversely impact one or more additional regions of the body, given the wide range of interdependence present. Fascia is a tissue which connects parts of the body together. Fascia is therefore also a pathway through which problems in one part of the body may adversely affect other areas of the body.

Fascia is a continuous sheet of densely packed fibrous collagen tissue enveloping the muscular system, internal organs, the vascular system, the nervous system, and skeletal structure. That is, the fascia is a continuous sheet, connecting all parts of a body together. Some portions of the fascia secure parts of the body together and in place, while other fascia allow other body parts to freely slide across each other without damage. Myofascial tissue is fascia tissue specifically surrounding muscular tissue.

Therapies have developed focused on addressing issues arising from fascial tissue structural misalignment. Indeed, much development in this area has focused on viewing the fascia in one part of the body influencing the health and function of other parts of the body. Using the metaphor of a continuous sheet connecting all body parts, it is logical that structural misalignment in one part of the sheet would influence other body parts connected via the sheet. For example, a spasming muscle can create abnormal tension in the surrounding myofascial tissue, which in turn creates abnormal tension on the continuous sheet of fascial tissue permeating the rest of the body. The fascial tissue also envelopes vascular tissue, such as blood vessels, which may be abnormally constricted due to fascia structural abnormalities in the continuous sheet from, for example, the spasming muscle. Such abnormally constricted blood vessels may have an impact of restricting oxygen and nutrient flow to these parts of the body, leading to numerous potential problems.

The present teachings focus on solutions for dealing with structural misalignments in myofascial tissue. Such structural misalignments can result in a myriad of bodily problems, including neck and low back pain, which can be quite severe, indeed debilitating in some circumstances. Problems with myofascial tissue arise as a result of injury, infection, stress, nutritional imbalance, over and/or under use of muscles, illness and pain, among other causes. Simply the force of gravity operating on the body can lead to misalignments.

Previous solutions to the problem of myofascial structural misalignments have included medications, physical therapy and hand held devices. Medications used to address myofascial tissue-related problems, such as for example anti-inflammatory agents and muscle relaxers can be accompanied by a wide array of undesirable side effects such as addiction as well as placing limitations on time and place of use, such as an inability to operate a vehicle. Physical therapy requires a second person be present to administer treatment to an affected area of the body, which is limiting for a person desiring to perform myofascial realignments alone or not having access to such a therapist in a time of need. Hand held devices wherein a user holds the device and applies pressure to a portion of the user's body affected by myofascial misalignments are limited in that the user cannot remain anatomically neutral when using such a device, because the user must exert multiple muscular forces to operate the device.

The present teachings describe apparatuses and methods which allow a user to self-administer a variable and targeted force to myofascial tissue requiring structural realignment to relieve associated symptoms. The present teachings overcome the aforementioned issues associated with current state of the art solutions, as will now be described in greater detail.

### SUMMARY

Embodiments of the present teachings include a myofascial release apparatus which is adapted for use by a user in substantially a vertical position, generally comprises a post member, a post affixing element, and at least one release member. The post affixing element is adapted to operatively couple the post member to the at least one release member. The at least one release member is adapted to reposition physical bodily structures in a user via myofascial tissue realignment when the user applies a body part directly to the at least one release member and applies a force. In one embodiment, a myofascial release system is disclosed, comprising a post member means, a post affixing means, and a release member means.

### BRIEF DESCRIPTION OF THE DRAWINGS

Embodiments of the present disclosure will be more readily understood by reference to the following figures, in which like reference numbers and designations indicate like elements.

FIG. 1 illustrates a cross-sectional view of a layer of skin, a layer of myofascial tissue and a layer of muscle tissue to which embodiments of the present teachings functionally operate upon.

FIG. 2a illustrates an exploded perspective view of a myofascial release apparatus, according to one embodiment of the present teachings.

FIG. 2b illustrates a side perspective view of a myofascial release apparatus, according to one embodiment of the present teachings.

FIG. 2c illustrates an exploded view of a release member and post affixing element, according to one embodiment of the present teachings.

FIG. 3a illustrates an exploded perspective view of a variable length post affixing element myofascial release apparatus, according to one embodiment of the present teachings.

FIG. 3b illustrates a side perspective view of a variable length post affixing element myofascial release apparatus, according to one embodiment of the present teachings.

FIG. 3c illustrates an exploded view of a release member and post affixing element, according to one embodiment of the present teachings.

FIG. 4 illustrates a side perspective view of a distance adjusting myofascial release apparatus, according to one embodiment of the present teachings.

### DETAILED DESCRIPTION OF THE PREFERRED EMBODIMENTS

### Overview

The present teachings describe a myofascial release apparatus and method, adapted for use by a user in a substantially vertical position (e.g., standing, seated, kneeling, leaning) Embodiments of the present teachings are generally designed to be vertically hung or freestanding in such a manner as to allow the user to physically interact with the myofascial release apparatus in the substantially vertical position to relieve structural abnormalities in myofascial tissue.

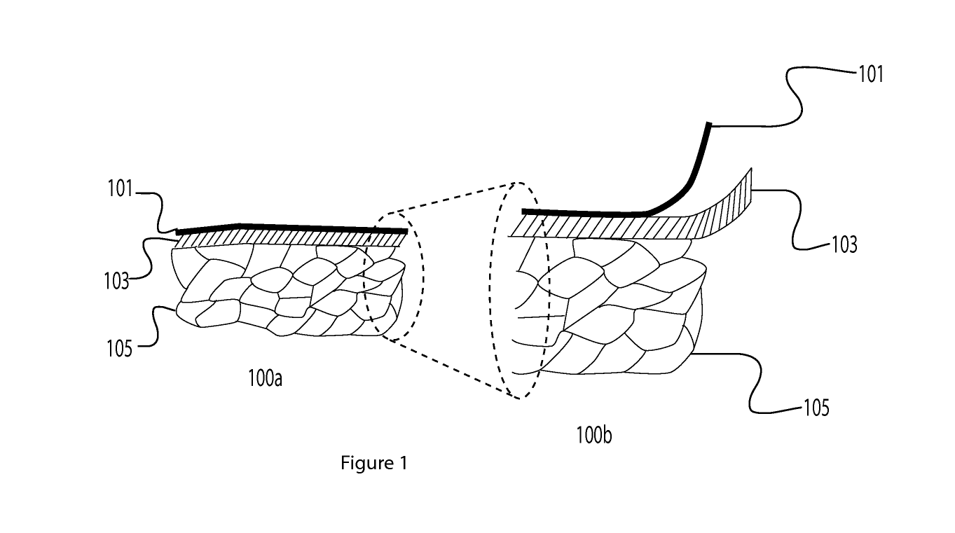

Referring now to FIG. 1, a cross-sectional view 100a of a layer of skin 101, a layer of myofascial tissue 103 and a layer of muscle tissue 105 is illustrated. A cross-sectional view 100b illustrates an expanded and exploded view of each of the layers and where each layer separates. Embodiments of the present teachings operate on the layer of myofascial tissue 103 to correct misalignments. It will be appreciated that although the layer of myofascial tissue 103 is primarily operated upon by embodiments of the present teachings, other layers are directly and/or indirectly contacted and/or affected by operation of the disclosed apparatus and methods.

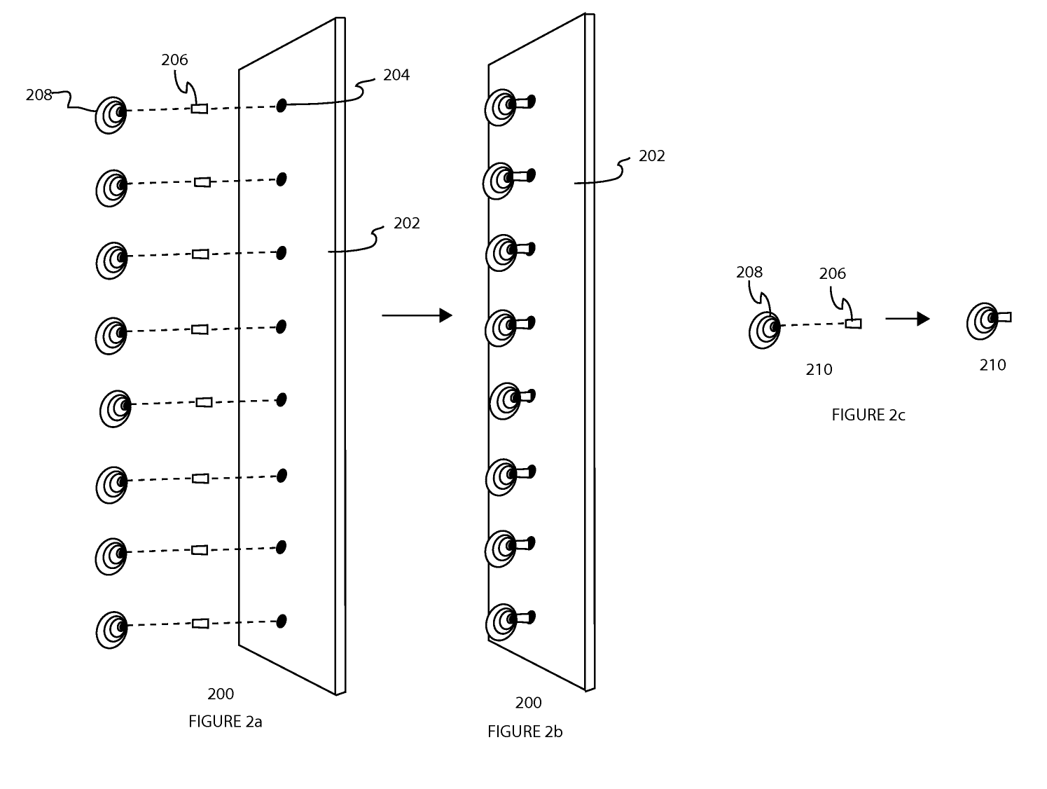

Referring now to FIG. 2a, FIG. 2b, and FIG. 2c according to one embodiment of the present teachings a myofascial release apparatus 200 comprising a post member 202, a post affixing element 206, and at least one release member 208 is disclosed. In one embodiment, a cavity 204 is adapted to accept the post affixing element 206 therein to secure the post affixing element 206 into a fixed position on the post member 202. For illustrative exemplary purposes in FIGS. 2a, 2b and 2c, the at least one release member 208 is generally spherical in shape although other shapes are possible without departing from the scope and spirit of the present teachings. In one embodiment, the at least one release member 208 comprises a rigid spherical contour having a proximate end and a distal end. The at least one release member 208 is mechanically coupled to the post member 202 via the post affixing element 206 at the proximate end of the at least one release member 208. In operation, a user applies an afflicted body part to the distal end of the at least one release member 208. In doing so the user applies a variable force which may be altered depending on the user's comfort and needs. For purposes of this disclosure an afflicted body part is defined as a body part having a myofascial tissue structural misalignment present, which may be causing pain or discomfort to the user. Such a myofascial tissue structural misalignment may be represented as a point of muscular tension in the afflicted body part, to which the myofascial release apparatus 200 may be used to correct such misalignment. Application of variable force by the user of the afflicted body part to the at least one release member 208 of the myofascial release apparatus 200 directly applies such variable force to the structural misalignment in the myofascial tissue layer 103, which leads to a release of the muscular tension, thereby correcting the structural misalignment. As described above, such myofascial misalignments in one part of the body can lead to problems and/or misalignments in other parts of the body. Therefore, correcting structural abnormalities in the myofascial tissue in one region of the body can lead to correcting problems in other areas of the body, such as for example blood flow issues and/or nerve issues which can lead to diminished or eliminated discomfort or pain in the user. It will be appreciated that for purposes of this disclosure, force is a vector quantity having components of magnitude and direction. As such, the myofascial release apparatus 200 is adapted to be used with variable force magnitude and direction as required by the needs of a user to release misaligned myofascial tissue. Although FIGS. 2a, 2b and 2c illustrate the post affixing element 206 in a generally perpendicular orientation with respect to the post member 202, this is for exemplary purposes only and it will be appreciated that other angles of orientation are within the scope and spirt of the present teachings, such as for example a post affixing element 206 having a forty-five degree angle with respect to the vertical axis of the post member 202.

FIG. 2a illustrates an exploded perspective view of the myofascial release apparatus 200, according to one embodiment of the present disclosure. The post member 202 comprises a surface upon which the post affixing element 206 is operatively coupled and mechanically attached thereto. Although FIG. 2a illustrates a flat planar surface, it will be appreciated that other surfaces are anticipated and within the scope and spirit of the present teachings. In some embodiments the post member 202 may comprise a non-flat surface having contours which are convex and/or concave.

FIG. 2b illustrates a side perspective view of a myofascial release apparatus 200, according to one embodiment of the present teachings. As shown, the post affixing element 206 is mechanically coupled to the at least one release member 208. Although FIG. 2b illustrates a single one of the at least one release member 208 mechanically coupled to the post affixing element 206, it will be appreciated that multiple release members may be affixed to the post affixing element 206 without departing from the scope and spirit of the present teachings. That is, in some embodiments multiple release members may optionally be mechanically coupled to the post affixing element 206.

FIG. 2c illustrates an exploded view of a portion of a myofascial release apparatus 210 of at least one release member 208 and a post affixing element 206, according to one embodiment of the present teachings. In one embodiment, the post affixing element 206 is removably coupled to the at least one release member 208, such that a user may replace the at least one release member 208 with a different release member.

Alternate variations of the myofascial release apparatus 210 include embodiments having a pliable spherical contour shaped at least one release member 208, such as for example a soft porous material. In such embodiments, a user is able to apply greater force to the myofascial release apparatus 210 as the pliable spherical contour is adapted to crush inward toward the post member 202. Other variations in shape to the at least one release member are possible and within the scope and spirit of the present teachings, such as for example a rigid elliptical contour and/or a pliable elliptical contour. In one embodiment, the at least one release member 208 comprises a substantially pointed shape at a distal end, which may be either rigid or pliable materials.

As briefly described above, the myofascial release apparatus 200 is generally intended to be operated by a user in a substantially vertical position, such as for example in a standing, seated, kneeling, or leaning orientation with respect to a vertical axis of the myofascial release apparatus 200. As such, the myofascial release apparatus 200 is easily usable by a handicapped person in a wheelchair, on crutches, or with other limited mobility issues without undue difficulty.

In one embodiment, the post affixing element 206 is removably affixed to the post member 202 such that a user may optionally extract the post affixing element 206 from the post member 202 at a cavity 204 and reattach the post affixing element 206 to another cavity on the post member 202. Thus the myofascial release apparatus 200 is adapted to be readily customized by a user to target different body parts as needed.

In one alternate embodiment, a myofascial release apparatus 200 is manufactured as a whole single piece, wherein a post affixing element 206 and at least one release member 208 are built into a post member 202. In this embodiment, construction materials may be natural or synthetic, such as for example wood, plastic or rubber.

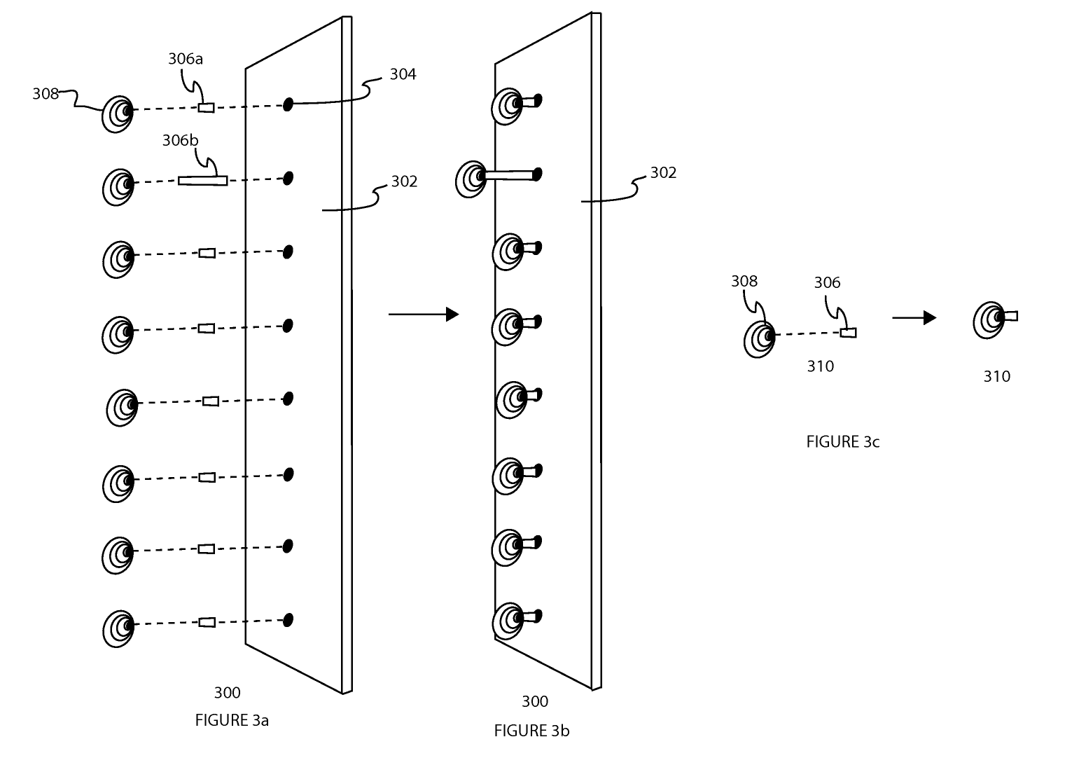

Referring now to FIG. 3a, FIG. 3b and FIG. 3c, a myofascial release apparatus 300 is disclosed. The myofascial release apparatus 300 comprises a post member 302, a variable length post affixing element 306, and a release member 308. As illustrated in FIGS. 3a, 3b, and 3c, a variable length post affixing element 306a may be different in length than another one of a variable length post affixing element 306b. Depending on specific myofascial structural misalignments, a user may optionally replace the variable length post affixing element 306a with the variable length post affixing element 306b. In some embodiments, the variable length post affixing element 306 is adapted to be telescoping such that a user may readily adjust the length dynamically as needed.

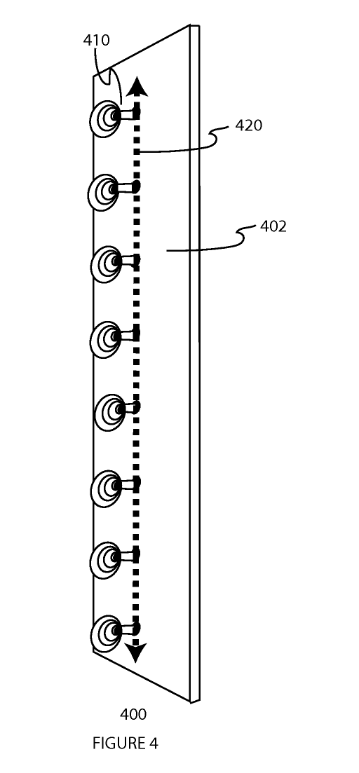

Referring now to FIG. 4, a myofascial release apparatus 400 is disclosed. The myofascial release apparatus 400 comprises a post member 402, a distance adjusting member 420 and a post affixing element affixed to a release member 410. In this embodiment, a distance between successive release members is adjustable. Although for illustrative exemplary purposes, FIG. 4 shows an adjustable vertical distance actuated by the distance adjusting member 420, it will be appreciated that the distance adjusting member 420 may also be adapted to adjust a distance in a horizontal and/or diagonal direction as required to correct myofascial misalignments in a user's body parts. In one embodiment, a distance adjusting member 420 is adjustable via a chain element. In this embodiment, a post affixing element affixed to a release member 410 is attached to a chain element wherein the chain element is movably connected to a post member 402 in such a manner as to allow the chain element to move with respect to the post member 402. Therefore, if a user requires a different alignment of release members 410, this can be achieved by actuating the chain element to realign the release members 410 to be in greater conformity to myofascial misalignments in a user's body part. In one embodiment, a microprocessor device, such as for example an Application Specific Integrated Circuit (“ASIC”) controls a chain drive element wherein a variable distance between successive release members 410 is controlled by such a microprocessor device. In one variation of this embodiment, the microprocessor may optionally be remotely controlling the variable distance between successive release members 410 via wireless connection protocols, such as for example Frequency Modulation, Amplitude Modulation, Phase Modulation, Bluetooth, and Infrared techniques.

Although the preferred embodiments of the present teachings have addressed issues related to realignment of myofascial tissue structural abnormalities, such embodiments are readily adapted to release tension in tendons, ligaments, improve lymphatic drainage and apply pressure to acupressure points for improved organ health. All such embodiments are within the scope and spirit of the present teachings.

The foregoing description illustrates exemplary implementations, and novel features, of aspects of an apparatus for correcting myofascial misalignments in a body. Alternative implementations are suggested, but it is impractical to list all alternative implementations of the present teachings. Therefore, the scope of the presented disclosure should be determined only by reference to the appended claims, and should not be limited by features illustrated in the foregoing description except insofar as such limitation is recited in an appended claim.

While the above description has pointed out novel features of the present disclosure as applied to various embodiments, the skilled person will understand that various omissions, substitutions, permutations, and changes in the form and details of the present teachings illustrated may be made without departing from the scope of the present teachings.

Each practical and novel combination of the elements and alternatives described hereinabove, and each practical combination of equivalents to such elements, is contemplated as an embodiment of the present teachings. Because many more element combinations are contemplated as embodiments of the present teachings than can reasonably be explicitly enumerated herein, the scope of the present teachings is properly defined by the appended claims rather than by the foregoing description. All variations coming within the meaning and range of equivalency of the various claim elements are embraced within the scope of the corresponding claim. Each claim set forth below is intended to encompass any apparatus or method that differs only insubstantially from the literal language of such claim, as long as such apparatus or method is not, in fact, an embodiment of the prior art. To this end, each described element in each claim should be construed as broadly as possible, and moreover should be understood to encompass any equivalent to such element insofar as possible without also encompassing the prior art. Furthermore, to the extent that the term “includes” is used in either the detailed description or the claims, such term is intended to be inclusive in a manner similar to the term “comprising”.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as“and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future. Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1.) A myofascial release apparatus, adapted for use by a user in a vertical position, comprising:
(a.) a post member, having a post affixing element adapted to be operatively coupled to the post member, and;
(b.) at least one release member, adapted to reposition physical bodily structures in the user, having a proximate end and a distal end, affixed at the proximate end to the post member via one of the at least one post affixing elements, wherein physical bodily structures in the user come into operational contact with the distal end of the at least one release member, whereby variable mechanical force is applied by the user to the distal end of the at least one release member to release structural abnormalities of physical bodily structures.

2.) The myofascial release apparatus of claim 1.), wherein the post member further comprises a cavity, adapted to accept the post affixing element therein.

3.) The myofascial release apparatus of claim 1.), wherein the distance separating a plurality of post affixing elements are separated by a predetermined fixed distance.

4.) The myofascial release apparatus of claim 1.), wherein the post affixing elements are separated by an adjustable distance.

5.) The myofascial release apparatus of claim 4.), wherein the adjustable distance separating the post affixing elements is adjustable via a chain element.

6.) The myofascial release apparatus of claim 1.), wherein the at least one release member comprises a rigid spherical contour on the distal end of the at least one release member.

7.) The myofascial release apparatus of claim 1.), wherein the at least one release member comprises a pliable spherical contour on the distal end of the at least one release member.

8.) The myofascial release apparatus of claim 1.), wherein the at least one release member comprises a rigid elliptical contour on the distal end of the at least one release member.

9.) The myofascial release apparatus of claim 1.), wherein the at least one release member comprises a pliable elliptical contour on the distal end of the at least one release member.

10.) The myofascial release apparatus of claim 5.), further comprising a microprocessor element, adapted to control the adjustable distance between each of the post affixing elements.

11.) A method of manufacturing a myofascial release apparatus, comprising:
(a.) providing a post member;
(b.) providing a post affixing element, adapted to be operatively coupled to the post member;
(c.) providing at least one release member, affixed to the post affixing element.

12.) The method of manufacturing of claim 11.) further comprising, providing a distance adjusting element, adapted to adjust a distance between each of the at least one post affixing elements.

13.) The method of manufacturing of claim 12.), wherein the distance adjusting element comprises a chain.

14.) A myofascial release system, comprising:
(a.) post member means for affixing a post affixing means, and;
(b.) release member means, affixed to the post affixing means, for repositioning myofascial structures.

15.) The myofascial release system of claim 14.), further comprising adjusting means for adjusting a distance between each respective one of the post affixing means.

16.) The myofascial release system of claim 15.), further comprising a microprocessor control means for controlling the adjusting means for adjusting the distance between each one of the post affixing means.

17.) The myofascial release apparatus of claim 1.), wherein the post affixing element comprises a variable length post affixing element.

18.) The myofascial release system of claim 14.), wherein the post affixing means comprise a variable length post affixing means.

19.) The myofascial release apparatus of claim 1.), wherein a plurality of release members are mechanically coupled to the post affixing element.

20.) The myofascial release system of claim 14.), wherein a plurality of release members are mechanically coupled to the post affixing means.
